(19) United States
(12) Patent Application Publication
(10) Pub. No.: US 2023/0328835 A1
(43) Pub. Date: Oct. 12, 2023

(54) METHODS AND APPARATUSES FOR A DATA TRANSMISSION AND A RNAU PROCEDURE OF A UE IN RRC INACTIVE STATE

(71) Applicant: Lenovo (Beijing) Limited, Beijing (CN)

(72) Inventors: Lianhai Wu, Beijing (CN); Ran Yue, Beijing (CN); Jie Shi, Beijing (CN); Mingzeng Dai, Shanghai (CN); Haiming Wang, Beijing (CN)

(73) Assignee: Lenovo (Beijing) Limited, Beijing (CN)

(21) Appl. No.: 18/042,511

(22) PCT Filed: Sep. 23, 2020
(86) PCT No.: PCT/CN2020/117140

§ 371 Date: Feb. 22, 2023

(51) Int. Cl. H04W 76/27

(52) U.S. Cl. CPC H04W 76/27

(57) ABSTRACT

Embodiments of the present disclosure relate to methods and apparatuses a data transmission and a radio access network based notification area update (RNAU) procedure of a user equipment (UE) in a radio resource control (RRC) inactive state. According to an embodiment of the present disclosure, a method includes: entering a RRC inactive state of a UE based on RRC configuration information; starting a timer for RNAU procedure; transmitting small data at the RRC inactive state of the UE; and in response to receiving response information corresponding to the transmitted small data, restarting the timer for RNAU procedure. The method further includes that the timer for RNAU procedure expires after the UE has triggered the small data transmission procedure. The UE may suspend the RNAU procedure. The UE may cancel or resume the RNAU procedure depending on the small data transmission procedure.

### TECHNICAL FIELD

The present application generally relates to wireless communication technology, and especially to methods and apparatuses for a data transmission and a radio access network based notification area update (RNAU) procedure of a user equipment (UE) in a radio resource control (RRC) inactive state.

### BACKGROUND

According to agreements of 3GPP (3rd Generation Partnership Project) standard documents, a RAN-based notification area update (RNAU) procedure can be periodically triggered by a UE based a configured timer. The purpose of a RNAU procedure is used to inform a network that the UE is still located in this radio access network (RAN) area or cell.

In 3GPP 5G system, concepts of small data and a small data transmission procedure are introduced for several use cases. Small data may also be named as a small data packet, a small data transmission, or a small size and infrequent data transmission. For example, according to an agreement of 3GPP TSG RAN Meeting #86, small data represents small size and infrequent data in an uplink (UL) of a UE which can be used for smartphone applications including a traffic from instant messaging services or used for non-smartphone applications including a traffic from wearables.

In general, any device that has intermittent small data in a RRC inactive state (i.e., RRC INACTIVE, RRC_INACTIVE, RRC Inactive, RRC_Inactive, or the like) or a RRC idle state (i.e., RRC IDLE, RRC_IDLE, RRC Idle, RRC_Idle, or the like) of a UE will benefit from enabling a small data transmission procedure in a RRC inactive state or a RRC idle state.

3GPP 5G networks are expected to increase network throughput, coverage, and robustness and reduce latency and power consumption. With the development of 3GPP 5G networks, various aspects need to be studied and developed to perfect the 5G technology.

### SUMMARY

One object of embodiments of the present disclosure is to provide novel mechanisms for a data transmission and a RNAU procedure of a UE in a RRC inactive state.

Some embodiments of the present application provide a method, which may be performed by a UE. The method includes: entering a RRC inactive state of a UE based on RRC configuration information; starting a timer for RNAU procedure; transmitting small data at the RRC inactive state of the UE; and in response to receiving response information corresponding to the transmitted small data, restarting the timer for RNAU procedure.

Some embodiments of the present application provide a method, which may be performed by a UE. The method includes: entering a RRC inactive state of a UE based on RRC configuration information; starting a timer for RNAU procedure; and in response to an expiry of the timer for RNAU procedure and in response to determining that small data is available for transmission, performing one of the RNAU procedure and a small data transmission procedure.

Some embodiments of the present application provide a method, which may be performed by a UE. The method includes: entering a RRC inactive state of a UE based on RRC configuration information; starting a timer for RNAU procedure; and triggering a small data transmission procedure.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the abovementioned method performed by a UE.

Some embodiments of the present application provide a method, which may be performed by a base station (BS). The method includes: transmitting a RRC message, the RRC message is used to configure a UE to enter a RRC inactive state; transmitting control signaling to enable a small data transmission procedure for the UE; transmitting configuration information regarding a timer for RNAU procedure of the UE; and starting a periodic RNAU guard timer.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the abovementioned method performed by a BS.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates a periodic RNAU procedure with UE context relocation according to some embodiments of the present application;

FIG. 3 illustrates a contention-based random access (CBRA) procedure with 4-step random access (RA) type according to some embodiments of the present application;

FIG. 4 illustrates a CBRA procedure with 2-step RA type according to some embodiments of the present application;

FIG. 5 illustrates a configured grant (CG) procedure according to some embodiments of the present application;

FIG. 6 illustrates an exemplary flow chart of a method for transmitting small data according to some embodiments of the present application;

FIG. 7 illustrates an exemplary flow chart of a method for starting a periodic RNAU guard timer according to some embodiments of the present application;

FIG. 8 illustrates a further exemplary flow chart of a method for performing a small data transmission procedure according to some embodiments of the present application;

FIG. 9 illustrates another exemplary flow chart of a method for triggering a small data transmission procedure according to some embodiments of the present application; and

FIG. 10 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8, BSG, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As illustrated and shown in FIG. 1, a wireless communication system 100 includes at least one UE 101 and at least one BS 102. In particular, the wireless communication system 100 includes one UE 101 (e.g., UE 101a) and two BSs 102 (e.g., BS 102a and BS 102b) for illustrative purpose. Although a specific number of UE(s) 101 and BS(s) 102 are depicted in FIG. 1, it is contemplated that any number of UE(s) 101 and BS(s) 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via UL communication signals.

In some embodiments of the present application, each of UE(s) 101 may be deployed an IoT application, an enhanced mobile broadband (eMBB) application and/or an ultra-reliable and low latency communication (URLLC) application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102. BS(s) 102 may communicate directly with each other. For example, BS(s) 102 may communicate directly with each other via Xn interface or X2 interface.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G new radio (NR) of the 3GPP protocol, wherein BS(s) 102 transmit data using an OFDM modulation scheme on the DL and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each of BS(s) 102 may include one or more cells. Each UE(s) 101 may perform a cell section procedure between different cell(s) of different BS(s). Each UE(s) 101 may perform a RNAU procedure from the last serving cell of a BS to a cell of the current BS. For example, in the wireless communication system 100 as illustrated and shown in FIG. 1, BS 102a may function as the last serving BS, and BS 102b may function as the current BS. If there is a handover need, UE 101a as illustrated and shown in FIG. 1 may perform a RNAU procedure from a cell of BS 102a to a cell of BS 102b.

According to agreements of 3GPP standard documents, a UE in a RRC connection state (i.e., RRC CONNECTION, RRC_CONNECTION, RRC_CONNECTED, RRC_Connected, or the like) will enter a RRC inactive state (i.e., RRC INACTIVE, RRC_INACTIVE, RRC Inactive, RRC_Inactive, or the like) if the UE receives RRCRelease message including suspending configuration information (i.e., Suspend Indication). RRC_INACTIVE is a state in which a UE has a connection between the serving cell and an AMF (an access and mobility management function) and the UE can move within an area configured by NG-RAN without notifying the NG-RAN. In a RRC_INACTIVE state, the last serving BS keeps the UE's context and the UE-associated NG connection with the serving AMF and the UPF (user plane function).

After a UE transits to a RRC_INACTIVE state, a BS may configure the UE with a periodic radio access network based notification area (RNA) update timer value. The NG-RAN node uses a guard timer with a value longer than the RNA update (RNAU) timer value provided to the UE. Upon an expiry of the periodic RNAU timer without any notification from the UE, the BS of the NG-RAN shall initiate an access network (AN) release procedure if the periodic RNAU guard timer expires.

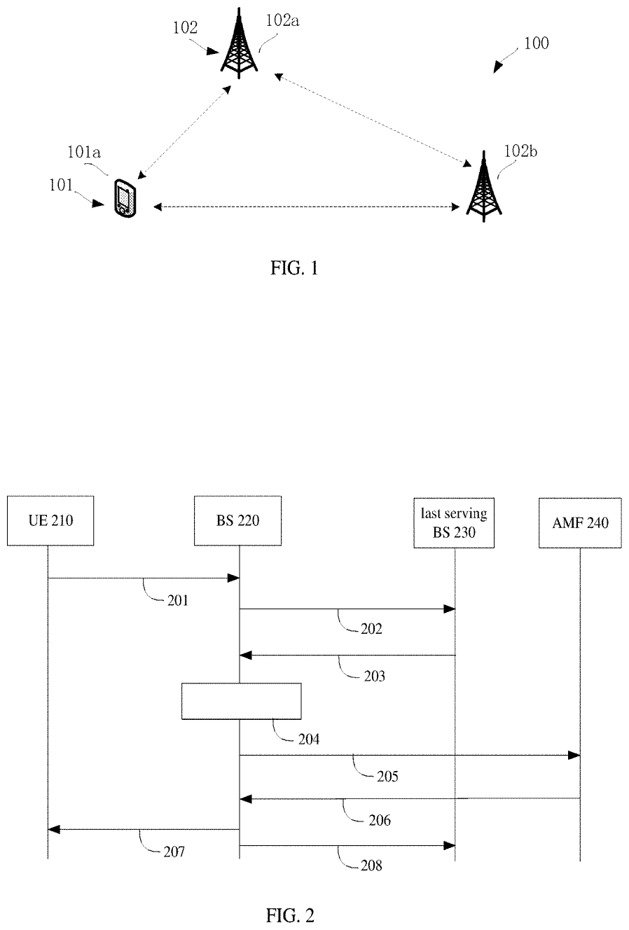

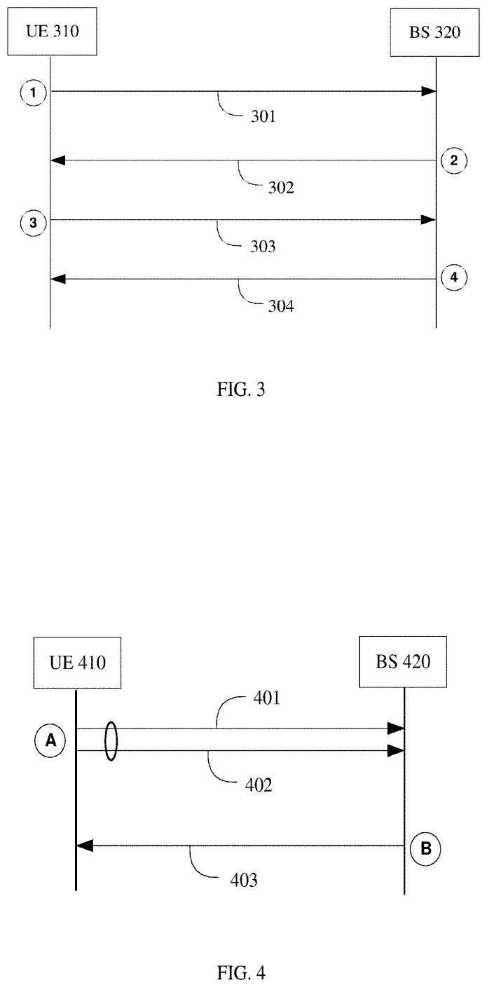

Generally, a UE in a RRC_INACTIVE state can be configured by the last serving NG-RAN node with a RNA. The RNA can cover a single cell or multiple cells. A RAN-based notification area update (RNAU) procedure is periodically sent by the UE and is also sent when a cell reselection procedure of the UE selects a cell that does not belong to the configured RNA. A RNAU procedure may be triggered periodically. Details regarding a RNAU procedure are described in FIGS. 2 and 3.

FIG. 2 is a periodic RNAU procedure with UE context relocation according to some embodiments of the present application.

The embodiments of FIG. 2 show a procedure of a UE (e.g., UE 210) communicating with a base station (e.g., BS 220) and the last serving BS (e.g., last serving BS 230), which operate under the control of a core network entity (e.g., AMF 240). In some examples, UE 210 may function as UE 101a in FIG. 1. BS 220 may function as BS 102a in FIG. 1. The last serving BS 230 may function as BS 102b in FIG. 1.

Referring to FIG. 2, in operation 201, UE 210 may transmit a RRC resume request message, which includes I-RNTI (Inactive Radio Network Temporary Identifier) allocated by the last serving BS 230 and an appropriate cause value. For example, the appropriate cause value is RAN notification area update. In operation 202, BS 220 transmits a retrieve UE context request message, to request the last serving BS 230 to provide context of UE 210. In operation 203, the last serving BS 230 may provide the context of UE 210.

In operation 204, BS 220 may move UE 210 to a RRC_CONNECTED state, or send UE 210 back to a RRC_IDLE state (in this case, RRCRelease message is sent by BS 220), or send UE 210 back to a RRC_INACTIVE state as assumed in the following. In operation 205, in order to perform a path switch procedure, BS 220 may transmit a path switch request message to AMF 240. In operation 206, AMF 240 may transmit a path switch request response message to BS 220.

In operation 207, BS 220 may keep UE 210 in a RRC_INACTIVE state by transmitting RRCRelease message which includes Suspend Indication. In operation 208, BS 220 may trigger to release resource(s) of UE 210 at the last serving BS 230 by transmitting an UE context release message.

According to 3GPP standard documents, two types of random access (RA) procedures are supported: 4-step RA type with message 1 (i.e., MSG1, MSG.1, or the like); and 2-step RA type with message A (i.e., MSGA, MSG.A, or the like). Both types of RA procedures support contention-based random access (CBRA) and contention-free random access (CFRA). Details are described in FIGS. 3 and 4.

FIG. 3 is a contention-based random access (CBRA) procedure with 4-step random access (RA) type according to some embodiments of the present application. The embodiments of FIG. 3 show a procedure of a UE (e.g., UE 310) communicating with a base station (e.g., BS 320). In some examples, UE 310 may function as UE 101a in FIG. 1. BS 320 may function as BS 102a or BS 102b in FIG. 1.

In the embodiments of FIG. 3, four steps of the CBRA procedure are:
(1) In operation 301, UE 310 transmits Random Access Preamble via message 1 (i.e., MSG1, MSG.1, Msg1, Msg.1, or the like) to BS 320.
(2) In operation 302, UE 310 receives Random Access Response via message 2 (i.e., MSG2, MSG.2, Msg2, Msg.2, or the like) from BS 320.
(3) In operation 303, UE 310 transmits message 3 (i.e., MSG3, MSG.3, Msg3, Msg.3, or the like) to the serving cell of BS 320:
   For initial access procedure:
      UE 310 conveys the RRC Connection Request which is generated by the RRC layer and transmitted via a common control channel (CCCH).
   For RRC Connection Re-establishment procedure:
      UE 310 conveys the RRC Connection Re-establishment Request which is generated by the RRC layer and transmitted via CCCH.
   In the procedure to resume the RRC connection:
      UE 310 conveys the RRC Connection Resume Request which is generated by the RRC layer and transmitted via CCCH.
      UE 310 conveys a Resume identify (ID) to resume the RRC connection state.
(4) In operation 304, UE 310 receives message 4 (i.e., MSG4, MSG.4, Msg4, Msg.4, or the like) from BS 320 for a contention resolution purpose.

FIG. 4 is a CBRA procedure with 2-step RA type according to some embodiments of the present application. The embodiments of FIG. 4 show a procedure of a UE (e.g., UE 410) communicating with a base station (e.g., BS 420). In some examples, UE 410 may function as UE 101a in FIG. 1. BS 420 may function as BS 102a or BS 102b in FIG. 1.

In the embodiments of FIG. 4, message A (i.e., MSGA, MSG.A, MsgA, Msg.A, or the like) of the 2-step RA type includes a preamble on PRACH (Physical Random Access Channel) and a payload on a physical uplink shared channel (PUSCH).

After MSGA is transmitted to BS 420 in operations 401 and 402, UE 410 monitors a response from BS 420 (i.e., a network response). For CFRA, a dedicated preamble and a PUSCH resource are configured for MSGA transmission, and upon receiving the response from BS 420, UE 410 ends the RA procedure. For CBRA, if a contention resolution is successful upon receiving the response from BS 420, UE 410 ends the RA procedure.

In operation 403, if a fallback indication is received in message B (i.e., MSGB, MSG.B, MsgB, Msg.B, or the like) from BS 420, UE 410 performs MSG3 transmission using a UL grant which is scheduled in the fallback indication and monitors a contention resolution. If the contention resolution is not successful after MSG3 (re)transmission(s), UE 410 goes back to MSGA transmission.

Regarding a small data transmission procedure using a random access channel (RACH), UL data is multiplexed with RRCResumeRequest message, which can be included in MSG3 in FIG. 3 or MSGA in FIG. 4. RRCRelease message responds the RRCResumeRequest message and ends the small data transmission procedure. The RRCRelease message is transmitted in MSG4 in FIG. 3 or MSGB in FIG. 4.

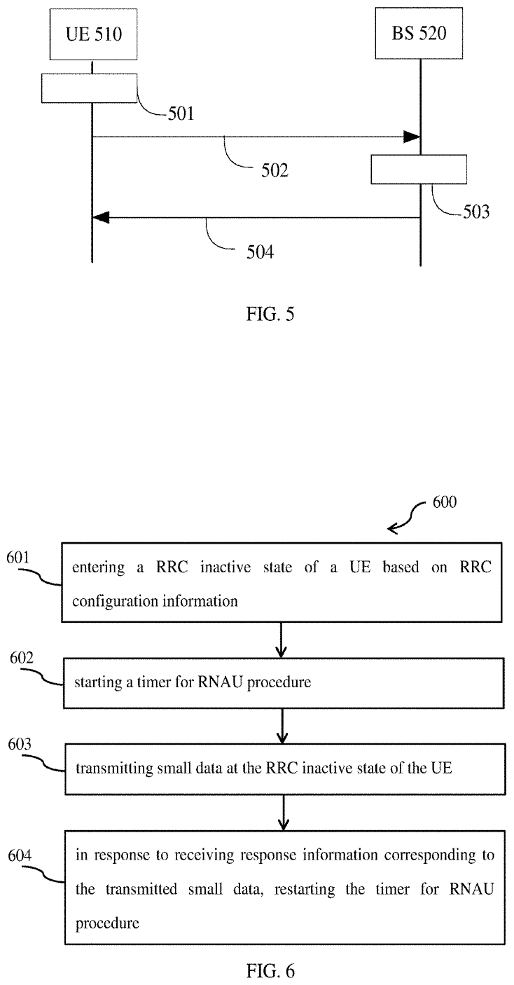

Regarding a small data transmission procedure using a configured grant (CG), a transmission using a CG allows one UL transmission from a RRC_Inactive state using a preconfigured UL resource without performing a RA procedure. Details are described in FIG. 5.

FIG. 5 is a configured grant (CG) procedure according to some embodiments of the present application. The embodiments of FIG. 5 show a procedure of a UE (e.g., UE 510) communicating with a base station (e.g., BS 520). In some examples, UE 510 may function as UE 101a in FIG. 1. BS 520 may function as BS 102a or BS 102b in FIG. 1.

In the embodiments of FIG. 5, in operation 501, UE 510 is in a RRC_INACTIVE state, and a CG is enabled in a cell of UE 510. In operation 502, UE 510 transmits a RRC resume request message, in which data is multiplexed. In operation 503, BS 520 makes a decision to move UE 510 back to a RRC_Inactive state. In operation 504, BS 520 transmits, to UE 510, a RRC connection release message including Suspend Indication.

Generally, several issues need to be solved, for example, how to handle a timer for RNAU procedure after a UE in a RRC inactive state transmits small data; how to handle a guard timer in a network side (e.g., a BS) considering a small data transmission for a RRC inactive state of a UE; which procedure (RNAU or a small data transmission procedure) should be performed when a timer for RNAU procedure expires before a transmission occasion of small data; whether should the RNAU be performed or not upon an expiry of a timer for RNAU procedure when a UE has an ongoing RACH procedure or a CG for small data; and which RACH resource should be used for a RNAU procedure if a separate RACH procedure is designed for an initial access procedure and a small data transmission procedure. Embodiments of the present application aim to solve at least one of the above issues and will be described as below.

FIG. 6 illustrates an exemplary flow chart of a method for transmitting small data according to some embodiments of the present application.

The method 600 illustrated in FIG. 6 may be implemented by a UE (e.g., UE 101, UE 210, UE 310, UE 410, or UE 510 as illustrated and shown in FIGS. 1-5, respectively). Although described with respect to a UE, it should be understood that other devices may be configured to perform a method similar to that of FIG. 6.

As shown in FIG. 6, in operation 601, a UE (e.g., UE 101a as illustrated and shown in FIG. 1) enters a RRC inactive state based on RRC configuration information. In operation 602, the UE starts a timer for RNAU procedure. A timer for RNAU procedure may also be named as a timer for RNAU, a timer for periodic RNAU procedure, or a timer for periodic RNAU.

In operation 603, the UE transmits small data at the RRC inactive state. In an embodiment, the UE transmits small data in a 4-step RACH procedure. In a further embodiment, the UE transmits small data in a 2-step RACH procedure. In another embodiment, the UE transmits small data using a CG.

In operation 604, if the UE receives response information corresponding to the transmitted small data, the UE may restart the timer for RNAU procedure. In some embodiments, the response information received by the UE is at least one of:
(1) a RRC release message;
(2) hybrid automatic repeat request-acknowledgement (HARQ-ACK) feedback information corresponding to the small data;
(3) successful data transmission confirmation information; and
(4) an indication to restart the timer for RNAU procedure.

In particular, according to some embodiments of the present application, a successful data transmission in a small data transmission procedure can also be used to indicate a serving cell of a UE because the serving cell can receive small data from this UE. There may be following two indicating options:

Implicit option: a UE may receive a feedback or a response from a BS, after the
UE transmits small data using a RACH procedure or a CG. Then, the UE can confirm the successful data transmission based on the feedback or response. The UE restarts the timer for RNAU procedure upon receiving the feedback or the successful data transmission.
   (1) In the case of a small data transmission procedure in 4-step RACH, a UE may restart the timer for RNAU procedure when the UE receives Msg4. The Msg4 may include one RRC message, e.g., RRCRelease message, or other information indicating successful data reception.
   (2) In the case of a small data transmission procedure in 2-step RACH, a UE may restart the timer for RNAU procedure when the UE receives MsgB. The MsgB may include one RRC message, e.g., RRCRelease message, or other information indicating successful data reception.
   (3) In the case of a small data transmission procedure in a CG, a UE may restart the timer for RNAU procedure when the UE receives one RRC message, e.g., RRCRelease message. Alternatively, the UE may restart the timer for RNAU procedure when the UE receives the ACK/NACK indication in a physical layer of the UE, if there is no feedback in the RRC layer of the UE.
Explicit option: a BS can explicitly indicate whether the timer for RNAU procedure should be restarted during a small data transmission procedure.
   (1) In the case of a small data transmission procedure in 4-step RACH, a UE may restart the timer for RNAU procedure when the UE receives an indication to restart the timer for RNAU procedure in Msg4.
   (2) In the case of a small data transmission procedure in 2-step RACH, a UE may restart the timer for RNAU procedure when the UE receives an indication to restart the timer for RNAU procedure in MsgB.
   (3) In the case of a small data transmission procedure in a CG, a UE may restart the timer for RNAU procedure when the UE receives an indication to restart the timer for RNAU procedure.

Details described in the embodiments as illustrated and shown in FIGS. 1-5 and 7-10, especially, contents related to specific operations for a data transmission and a RNAU procedure of a UE in a RRC inactive state, are applicable for the embodiments as illustrated and shown in FIG. 6. Moreover, details described in the embodiments of FIG. 6 are applicable for all the embodiments of FIGS. 1-5 and 7-10.

In some embodiments of the present application, a guard timer in a network side (e.g., a BS) needs to be handled with considering a small data transmission procedure for a UE which is in a RRC inactive state. In particular, there may be two options as below:
Implicit option: after a UE transmits small data using a RACH resource or a CG, the UE may receive a feedback or a response from a BS. The BS needs to restart the periodic RNAU guard timer after transmitting the feedback in response to receiving the small data from the UE.
Explicit option: a BS can explicitly indicate whether the timer for RNAU procedure should be restarted during a small data transmission procedure. The BS needs to restart the periodic RNAU guard timer after transmitting the explicit indication in response to receiving the small data from the UE.

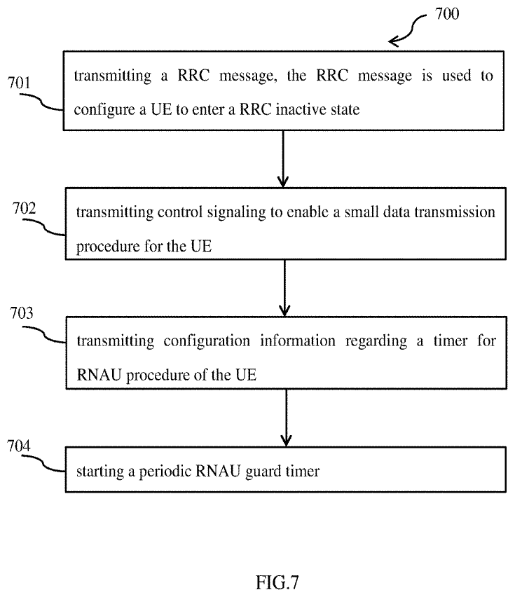

FIG. 7 illustrates an exemplary flow chart of a method for starting a periodic RNAU guard timer according to some embodiments of the present application.

The method illustrated in FIG. 7 may be implemented by a BS (e.g., BS 102a or BS 102b as shown and illustrated in FIG. 1). Although described with respect to a BS, it should be understood that other devices may be configured to perform a method similar to that of FIG. 7.

As shown in FIG. 7, in operation 701, a BS (e.g., BS 102a as illustrated and shown in FIG. 1) transmits a RRC message. The RRC message is used to configure a UE (e.g., UE 101, UE 210, UE 310, UE 410, or UE 510 as illustrated and shown in FIGS. 1-5, respectively) to enter a RRC inactive state.

In operation 702, the BS transmits control signaling to enable a small data transmission procedure for the UE. In operation 703, the BS transmits configuration information regarding a timer for RNAU procedure of the UE. In operation 704, the BS starts a periodic RNAU guard timer.

In some embodiments, the BS further receives small data from the UE. Upon receiving the small data, the BS may transmit, to the UE, response information corresponding to the received small data. After transmitting the response information, the BS may restart the periodic RNAU guard timer.

In an embodiment, the response information corresponding to the received small data may be at least one of:
(1) a RRC release message;
(2) HARQ-ACK feedback information corresponding to the received small data; and
(3) successful data transmission confirmation information.

Details described in the embodiments as illustrated and shown in FIGS. 1-6 and 8-10, especially, contents related to specific operations for a data transmission and a RNAU procedure of a UE in a RRC inactive state, are applicable for the embodiments as illustrated and shown in FIG. 7. Moreover, details described in the embodiments of FIG. 7 are applicable for all the embodiments of FIGS. 1-6 and 8-10.

The following texts describe specific Embodiments 1-3 of the methods as shown and illustrated in FIGS. 6 and 7, which adopt some of the above implicit and explicit options.

### Embodiment 1

According to Embodiment 1, a UE (e.g., UE 101a as shown and illustrated in FIG. 1) and a BS (e.g., BS 102a as shown and illustrated in FIG. 1) perform a small data transmission procedure in 4-step RACH by following steps:
(1) Step 1: the UE receives RRCRelease message including Suspend Indication. Then, the UE enters a RRC_INACTIVE state.
   One indication may be added in the RRCRelease message, to enable a small data transmission procedure.
   A dedicated RACH resource may be included in the RRCRelease message.
   If a timer for RNAU procedure is configured, the UE starts this timer.
(2) Step 2: the UE transmits Random Access Preamble.
   If a dedicated preamble is configured, the UE uses the dedicated preamble.
(3) Step 3: the UE receives Random Access Response (RAR).
   The UL grant is included in the RAR.
(4) Step 4: the UE transmits Msg3 to the serving cell of the BS.
   Data multiplexed with RRCResumeRequest message is transmitted in Msg3.
(5) Step 5: the BS transmits Msg4 after receiving Msg3 from the UE.
   If the BS would like to configure the UE back to a RRC_INACTIVE state, the BS transmits RRCRelease message including Suspend Indication to the UE. Also, the RRCRelease message includes a feedback corresponding to the small data received from the UE.
   The BS may restart a periodic RNAU guard timer after transmitting the feedback corresponding to the small data received from the UE.
(6) Step 6: the UE receives Msg4 for a contention resolution purpose.
   The UE restarts the timer for RNAU procedure when the UE receives confirmation information associated with the UL data transmission.

### Embodiment 2

According to Embodiment 2, a UE (e.g., UE 101a as shown and illustrated in FIG. 1) and a BS (e.g., BS 102a as shown and illustrated in FIG. 1) perform a small data transmission procedure in 2-step RACH by following steps:
(1) Step 1: the UE receives RRCRelease message including Suspend Indication. Then, the UE enters a RRC_INACTIVE state.
   One indication may be added in the RRCRelease message, to enable a small data transmission procedure.
   A dedicated RACH resource may be included in the RRCRelease message.
   If a timer for RNAU procedure is configured, the UE starts this timer.
(2) Step 2: the UE transmits MsgA to the serving cell of the BS.
   Data multiplexed with RRCResumeRequest message is transmitted in PUSCH.
(3) Step 3: the BS transmits MsgB after receiving MsgA.
   If the BS would like to configure the UE back to a RRC_Inactive state, the BS transmits RRCRelease message including Suspend Indication to the UE. Also, the RRCRelease message includes a feedback corresponding to the small data received from the UE.
   The BS may restart a periodic RNAU guard timer after transmitting the feedback corresponding to the small data received from the UE.
(4) Step 4: the UE receives MsgB for a contention resolution purpose.
   The UE restarts the timer for RNAU procedure when the UE receives confirmation information associated with the UL data transmission

### Embodiment 3

According to Embodiment 3, a UE (e.g., UE 101a as shown and illustrated in FIG. 1) and a BS (e.g., BS 102a as shown and illustrated in FIG. 1) perform a small data transmission procedure using a CG by following steps:
(1) Step 1: the UE receives RRCRelease message including Suspend Indication. Then, the UE enters a RRC_INACTIVE state.
   One indication may be added in the RRCRelease message, to enable a small data transmission procedure.
   A CG resource may be included in the RRCRelease message.
   If a timer for RNAU procedure is configured, the UE starts this timer.
(2) Step 2: the UE transmits small data to the serving cell of the BS using a CG if the UL data arrives.
   Data multiplexed with RRCResumeRequest message is transmitted.
(3) Step 3: the BS may transmit a feedback after receiving the small data included in a CG
   If the BS would like to configure the UE back to a RRC_INACTIVE state, the BS transmits RRCRelease message including Suspend Indication to the UE. Also, the RRCRelease message includes a feedback corresponding to the small data received from the UE.
   The BS may restart the periodic RNAU guard timer after transmitting the feedback corresponding to the small data received from the UE
(4) Step 4: the UE receives a feedback for a contention resolution purpose.
   The UE restarts the timer for RNAU procedure when the UE receives confirmation information associated with the UL data transmission.

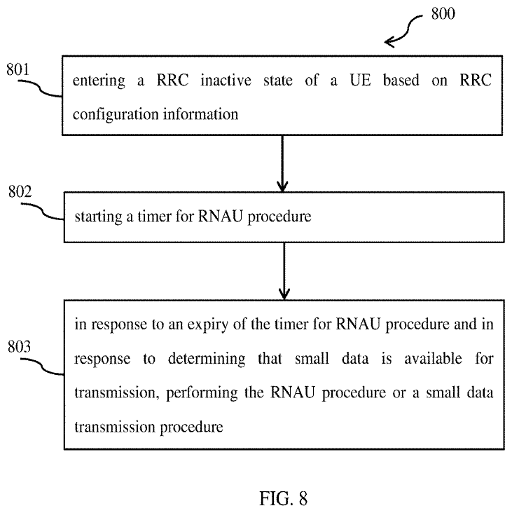

FIG. 8 illustrates a further exemplary flow chart of a method for performing a small data transmission procedure according to some embodiments of the present application.

The method illustrated in FIG. 8 may be implemented by a UE (e.g., UE 101, UE 210, UE 310, UE 410, or UE 510 as illustrated and shown in FIGS. 1-5, respectively). Although described with respect to a UE, it should be understood that other devices may be configured to perform a method similar to that of FIG. 8.

As shown in FIG. 8, in operation 801, a UE (e.g., UE 101a as illustrated and shown in FIG. 1) enters a RRC inactive state based on RRC configuration information. In operation 802, the UE starts a timer for RNAU procedure. In operation 803, if the timer for RNAU procedure expiries and if the UE determines that small data is available for transmission, the UE performs the RNAU procedure or a small data transmission procedure.

In an embodiment, if the UE only performs the small data transmission procedure, the UE may transmit a RRC resume request message. The RRC resume request message may include a cause. The cause may be RNA update and mobility origination (MO) data.

In a further embodiment, when the UE performs the RNAU procedure or the small data transmission procedure, the UE performs the RNAU procedure in priority. For example, the UE transmits a RRC resume request message. The RRC resume request message may be multiplexed with the available small data. Alternatively, the RRC resume request message may include an indication to indicate the available small data for transmission during the RNAU procedure.

Under certain scenarios, small data may be available for transmission in a UE side, but the timer for RNAU procedure expires before a transmission occasion of the small data. There may be following two embodiments.

In one embodiment, a small data transmission procedure is used for RNAU purpose to indicate a serving cell of a UE because the serving cell can receive small data from this UE. In particular, if the UE has available small data for transmission upon an expiry of the timer for RNAU procedure, the UE performs a small data transmission procedure. In this embodiment, the UE only performs the small data transmission procedure, but does not perform the RNAU procedure, and the UE further transmits a RRC resume request message. A new cause (e.g., RNA update and MO-data) may be added in RRC resume request message.

In another embodiment, a small data transmission procedure is not used for RNAU purpose to indicate a serving cell of a UE, and the UE performs a RNAU procedure in priority when the UE performs one of the RNAU procedure and the small data transmission procedure. In particular, after entering a RRC connection state, the UE can transmit small data. In Option 1 of this embodiment, small data can be carried during the RNAU procedure. For instance, the small data can be multiplexed with RRCResumeRequest message. In Option 2 of this embodiment, one indication is specified to indicate that small data is available for transmission during a RNAU procedure. Then, the network (e.g., a BS) can allow the UE to transit to a RRC connection state.

The following texts describe specific Embodiment 4 of the method as shown and illustrated in FIG. 8.

### Embodiment 4

According to Embodiment 4, a UE (e.g., UE 101a as shown and illustrated in FIG. 1) and a BS (e.g., BS 102a as shown and illustrated in FIG. 1) perform the following steps:
(1) Step 1: the UE receives RRCRelease message including Suspend Indication. Then, the UE enters a RRC_INACTIVE state.
   One indication is added in the RRCRelease message to enable a small data transmission procedure.
   A dedicated RACH resource may be included in the RRCRelease message.
   If a timer for RNAU procedure is configured, the UE starts this timer.
(2) Step 2: when the timer for RNAU procedure expires and the UE has UL data for transmission:
   Case 1: Small data transmission procedure can be used for RNAU purpose to indicate a serving cell of the UE.
      If the UE has available small data for transmission upon an expiry of the timer for RNAU procedure, the UE performs a small data transmission procedure.
      A new cause (e.g., RNA update and MO-data) may be included in RRCResumeRequest message.
   Case 2: Small data transmission procedure cannot be used for RNAU purpose to indicate a serving cell of the UE.
      The UE should perform a RNAU procedure in priority. After entering a RRC_Connected state, the UE can transmit the small data.
      Option 1: small data can be carried during a RNAU procedure. The small data can be multiplexed with RRCResumeRequest message for the RNAU purpose to indicate a serving cell of the UE.
      Option 2: one indication is specified to indicate that small data is available for transmission during a RNAU procedure. Then, a network can allow the UE to transit to a RRC_Connected state.

Details described in the embodiments as illustrated and shown in FIGS. 1-7, 9, and 10, especially, contents related to specific operations for a data transmission and a RNAU procedure of a UE in a RRC inactive state, are applicable for the embodiments as illustrated and shown in FIG. 8. Moreover, details described in the embodiments of FIG. 8 are applicable for all the embodiments of FIGS. 1-7, 9, and 10.

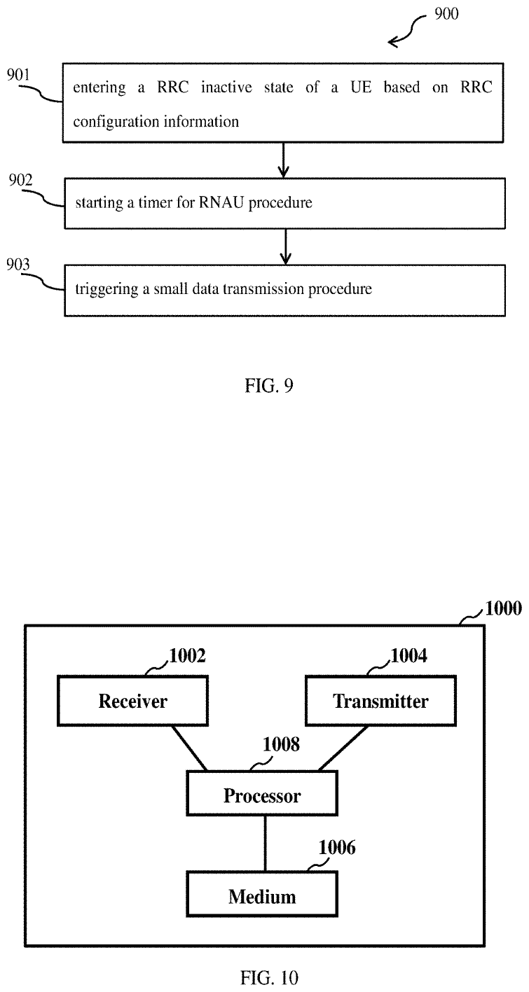

FIG. 9 illustrates another exemplary flow chart of a method for triggering a small data transmission procedure according to some embodiments of the present application.

The method illustrated in FIG. 9 may be implemented by a UE (e.g., UE 101, UE 210, UE 310, UE 410, or UE 510 as illustrated and shown in FIGS. 1-5, respectively). Although described with respect to a UE, it should be understood that other devices may be configured to perform a method similar to that of FIG. 9.

As shown in FIG. 9, in operation 901, a UE (e.g., UE 101a as illustrated and shown in FIG. 1) enters a RRC inactive state based on RRC configuration information. In operation 902, the UE starts a timer for RNAU procedure. In operation 903, the UE triggers a small data transmission procedure.

In some embodiments, the UE reports a capability for the small data transmission procedure. The capability includes at least one of: a 4-step RACH procedure; a 2-step RACH procedure; and a CG.

In some embodiments, the UE receives the RRC configuration information. the RRC configuration information may indicate that at least one of a 4-step RACH procedure, a 2-step RACH procedure, and a CG is allowed to be used for a small data transmission procedure at the RRC inactive state of the UE.

In some embodiments, the UE receives a RRC release message, which includes an indication to enable the small data transmission procedure. In some embodiments, the UE suspends the RNAU procedure upon an expiry of the timer for RNAU procedure.

In some embodiments, if the UE receives response information regarding the small data transmission procedure, the UE cancels the RNAU procedure and restarts the timer for RNAU procedure. In some other embodiments, if the UE does not receive any response information after a pre-configured window in time domain, the UE performs the RNAU procedure.

In some embodiments, if the timer for RNAU procedure expires, the UE performs the RNAU procedure and continues the small data transmission procedure in parallel. In some other embodiments, if the timer for RNAU procedure expires, the UE performs the RNAU procedure and stops the small data transmission procedure.

Under certain scenarios, small data is available for transmission in a UE side, but the timer for RNAU procedure expires when the UE is waiting for a response. There may be following two embodiments.

In one embodiment, a small data transmission procedure is used for RNAU purpose to indicate a serving cell of a UE. In particular, a UE may suspend a RNAU procedure and continue to monitor a response from a network (e.g., a BS). If the UE can receive the response from the network, the UE may cancel a RNAU procedure and restart the timer for RNAU procedure. If the UE cannot receive the response from the network after one preconfigured or predefined time window in time domain, the UE may perform a RNAU procedure.

In another embodiment, a small data transmission procedure is not used for RNAU purpose to indicate a serving cell of a UE. In one option of this embodiment, a RNAU procedure and a small data transmission procedure (e.g., using a CG) can be performed in parallel. In another option of this embodiment, the UE performs the RNAU procedure but stops the small data transmission procedure.

The following texts describe specific Embodiment 5 of the method as shown and illustrated in FIG. 9.

### Embodiment 5

According to Embodiment 5, a UE (e.g., UE 101a as shown and illustrated in FIG. 1) and a BS (e.g., BS 102a as shown and illustrated in FIG. 1) perform the following steps:
(1) Step 1: the UE receives RRCRelease message including Suspend Indication. Then, the UE enters a RRC_INACTIVE state.
   One indication is added in the RRCRelease message, to enable a small data transmission procedure.
   A dedicated RACH resource may be included in the RRCRelease message.
   If a timer for RNAU procedure is configured, the UE starts this timer.
(2) Step 2: the UE has small data for transmission in buffer. The UE performs a RACH procedure for a small data transmission.
   2-step RACH procedure, 4-step RACH procedure or a CG may be triggered to transmit small data.
(3) Step 3: when the timer for RNAU procedure expires while the UE has an ongoing RACH procedure for small data transmission:
   Case 1: Small data transmission procedure can be used for RNAU purpose to indicate a serving cell of the UE.
      Option 1: the UE suspends a RNAU procedure and continues to monitor a response for the ongoing RACH procedure. If the UE can receive the response, the UE cancels RNAU procedure and restarts the timer for RNAU procedure. If the UE cannot receive the response after one preconfigured or predefined time window in time domain, the UE performs a RNAU procedure.
   Case 2: Small data transmission procedure cannot be used for RNAU purpose to indicate a serving cell of the UE.
      Option 2: a RNAU procedure and a small data transmission procedure (e.g., by using a CG) can be performed in parallel.
      Option 3: the UE performs a RNAU procedure but stops the small data transmission procedure.

Details described in the embodiments as illustrated and shown in FIGS. 1-8 and 10, especially, contents related to specific operations for a data transmission and a RNAU procedure of a UE in a RRC inactive state, are applicable for the embodiments as illustrated and shown in FIG. 9. Moreover, details described in the embodiments of FIG. 9 are applicable for all the embodiments of FIGS. 1-8 and 10.

Under some scenarios, if separate RACH resources are designed for an initial access procedure and a small data transmission procedure, there is a need to determine which RACH resource should be used for a RNAU procedure.

According to some embodiments of the present application, if the UE has no available data for transmission when a timer for RNAU procedure expires, the UE may perform a RNAU procedure and use a RACH resource for an initial access procedure. The following texts describe specific Embodiment 6 within these embodiments.

### Embodiment 6

According to Embodiment 6, a UE (e.g., UE 101a as shown and illustrated in FIG. 1) and a BS (e.g., BS 102a as shown and illustrated in FIG. 1) perform the following steps:
(1) Step 1: the UE receives RRCRelease message including Suspend Indication. Then, the UE enters a RRC_INACTIVE state.
   One indication is added in the RRCRelease message, to enable a small data transmission procedure.
   A dedicated RACH resource may be included in the RRCRelease message.
   If a timer for RNAU procedure is configured, the UE starts this timer.
   There are separate RACH resources for the initial RACH procedure and a small data transmission procedure, respectively.
(2) Step 2: the timer for RNAU expires.
(3) Step 3: if the UE has no available data for transmission upon an expiry of the timer for RNAU procedure, the UE performs a RNAU procedure and uses the RACH resource for an initial access procedure.

FIG. 10 illustrates an exemplary block diagram of an apparatus according to some embodiments of the present application. In some embodiments of the present application, the apparatus 1000 may be a UE, which can at least perform any of the methods illustrated in FIGS. 6, 8, and 9. In some embodiments of the present application, the apparatus 1000 may be a BS, which can at least perform the method illustrated in FIG. 7.

As shown in FIG. 10, the apparatus 1000 may include at least one receiver 1002, at least one transmitter 1004, at least one non-transitory computer-readable medium 1006, and at least one processor 1008 coupled to the at least one receiver 1002, the at least one transmitter 1004, and the at least one non-transitory computer-readable medium 1006.

Although in FIG. 10, elements such as the at least one receiver 1002, the at least one transmitter 1004, the at least one non-transitory computer-readable medium 1006, and the at least one processor 1008 are described in the singular, the plural is contemplated unless limitation to the singular is explicitly stated. In some embodiments of the present application, the at least one receiver 1002 and the at least one transmitter 1004 are combined into a single device, such as a transceiver. In certain embodiments of the present application, the apparatus 1000 may further include an input device, a memory, and/or other components.

In some embodiments of the present application, the at least one non-transitory computer-readable medium 1006 may have stored thereon computer-executable instructions which are programmed to implement the operations of the methods, for example as described in view of any of FIGS. 6-9, with the at least one receiver 1002, the at least one transmitter 1004, and the at least one processor 1008.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. An apparatus, comprising:
a processor; and
a memory coupled with the processor, the processor configured to cause the apparatus to:
enter a radio resource control (RRC) inactive state of the apparatus based on RRC configuration information;
start a timer fora radio access network based notification area update (RNAU) procedure;
transmit small data at the RRC inactive state of the apparatus; and
restart the timer for the RNAU procedure in response to receiving response information corresponding to the transmitted small data.

2. The apparatus of claim 1, wherein the response information is at least one of:
a RRC release message;
hybrid automatic repeat request-acknowledgement (HARQ-ACK) feedback information corresponding to the small data;
successful data transmission confirmation information; or
an indication to restart the timer for the RNAU procedure.

3. The apparatus of claim 1, wherein, to transmit the small data, the processor is configured to cause the apparatus to:
transmit the small data in a 4-step random access channel (RACH) procedure;
transmit the small data in a 2-step RACH procedure; or
transmit the small data using a configured grant (CG).

4. A method An apparatus, comprising:
a processor; and
a memory coupled with the processor, the processor configured to cause the apparatus to:
enter a radio resource control (RRC) inactive state of the apparatus based on RRC configuration information;
start a timer for a radio access network based notification area update (RNAU) procedure; and
in response to an expiry of the timer for the RNAU procedure and in response to a determination that small data is available for transmission, perform one of the RNAU procedure or a small data transmission procedure.

5. The apparatus of claim 4, wherein the processor is configured to cause the apparatus to:
perform only the small data transmission procedure, procedure; and
transmit a RRC resume request message that includes a cause, the cause being a radio access network based notification area (RNA) update and mobility origination (MO) data.

6. The apparatus of claim 4, wherein the processor is configured to cause the apparatus to perform the RNAU procedure in priority.

7. The apparatus of claim 6, wherein the processor is configured to cause the apparatus to transmit a RRC resume request message, wherein the RRC resume request message:
is multiplexed with the small data that is available; or
includes an indication that the small data is available for transmission during the RNAU procedure.

8. A method, comprising:
entering a radio resource control (RRC) inactive state of a user equipment (UE) based on RRC configuration information;
starting a timer for a radio access network based notification area update (RNAU) procedure; and
triggering a small data transmission procedure.

9. The method of claim 8, further comprising:
reporting a capability for the small data transmission procedure, wherein the capability includes at least one of:
a 4-step random access channel (RACH) procedure;
a 2-step RACH procedure; or
a configured grant (CG).

10. The method of claim 8, further comprising:
receiving the RRC configuration information, wherein the RRC configuration information indicates that at least one of a 4-step RACH procedure, a 2-step RACH procedure, or a CG is allowed to be used for the small data transmission procedure at the RRC inactive state of the UE.

11. The method of claim 8, further comprising:
receiving a RRC release message, wherein the RRC release message includes an indication to enable the small data transmission procedure.

12. The method of claim 8, further comprising:
suspending the RNAU procedure in response to an expiry of the timer for the RNAU procedure.

13. The method of claim 12, further comprising:
cancelling the RNAU procedure and restarting the timer for the RNAU procedure in response to receiving response information regarding the small data transmission procedure; or
performing the RNAU procedure in response to not receiving the response information after a pre-configured window in time domain.

14. The method of claim 8, further comprising, in response to an expiry of the timer for the RNAU procedure:
performing the RNAU procedure and continuing the small data transmission procedure in parallel; or
performing the RNAU procedure and stopping the small data transmission procedure.

15. (canceled)
